(19) United States
(12) Patent Application Publication
(10) Pub. No.: US 2016/0190701 A1
(43) Pub. Date: Jun. 30, 2016

(54) ANTENNA APPARATUS

(71) Applicant: Samsung Electro-Mechanics Co., Ltd., Suwon-Si (KR)

(72) Inventors: Jeong Ki RYOO, Suwon-Si (KR); Jong Lae KIM, Suwon-Si (KR); Stakanov SERGEY, Suwon-Si (KR); Sung Youl CHOI, Suwon-Si (KR)

(73) Assignee: Samsung Electro-Mechanics Co., Ltd., Suwon-Si (KR)

(21) Appl. No.: 14/980,907

(22) Filed: Dec. 28, 2015

(30) Foreign Application Priority Data
Dec. 30, 2014 (KR) 10-2014-0193357

(51) Int. Cl. H01Q 9/27

(52) U.S. Cl. CPC H01Q 9/27

(57) ABSTRACT

An antenna apparatus includes a plurality of antenna elements. The plurality of antenna elements may be spaced apart from one another, and a direction of current flowing in each of the antenna elements may be set to be oriented outwardly from substantially the center of the plurality of antenna elements in a length direction of each of the antenna elements or inwardly toward the center in the length direction of each of the plurality of antenna elements.

### CROSS-REFERENCE TO RELATED APPLICATION(S)

This application claims the benefit of Korean Patent Application No. 10-2014-0193357 filed on Dec. 30, 2014 in the Korean Intellectual Property Office, the entire disclosure of which is incorporated herein by reference for all purposes.

### BACKGROUND

1. Field

The present disclosure relates to an antenna apparatus for transmitting and receiving a signal and/or power.

2. Description of Related Art

Mobile communications terminals such as cellular phones, personal digital assistants (PDAs), navigation devices, and notebook computers supporting wireless communications are essential devices in modern society. Such mobile communications terminals are becoming multi-functional devices supporting communications undertaken using code division multiple access (CDMA), wireless local area network (WLAN), global system for mobile communications (GSM), and digital multimedia broadcasting (DMB) communications standards, and here, an antenna apparatus is a key component in enabling these functions.

Such an antenna apparatus may also be used as an important component in non-contact type wireless communications schemes such as radio frequency identification (RFID), or near field communications (NFC), or in a non-contact type wireless power transmission.

As the antenna apparatus, a thin planar antenna formed by printing a conductive wire loop on a flexible printed circuit board (FPCB) may be attached to a battery or a cover of a device. However, in order to be attached to a battery, the antenna apparatus should have a special structure and manual operations are required to be performed several times, making manufacturing process thereof relatively inefficient.

Meanwhile, a chip antenna apparatus in the form of a surface-mounted device may be used instead of the FPCB antenna apparatus, but the chip antenna apparatus is relatively thick in a Z-axis direction, running counter to the tendency of lighter, thinner, shorter, and smaller apparatuses.

Small antenna apparatuses are generally known, however with the conventional small antenna apparatus, when a signal or power is transmitted to a coil or an antenna of a receiver, current loss is high and a region in which current is induced is narrow.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

According to one general aspect, an antenna apparatus includes: a plurality of antenna elements. The plurality of antenna elements are spaced apart from one another, and a direction of current flowing in each of the plurality of antenna elements is set to be oriented outwardly from substantially the center of the plurality of antenna elements in a length direction of each of the plurality of antenna elements or inwardly toward the center in the length direction of each of the plurality of antenna elements.

The number of the plurality of antenna elements may be two n-squared, n being a natural number greater than 0.

The center may be provided as a feed point.

The winding direction of conductors of each of the plurality of antenna elements may be the same as or opposite to each other, according to the directions of current.

According to another general aspect, an antenna apparatus includes: at least two antenna elements spaced apart from each other in a facing manner in a portion of a substrate, wherein conductors are wound around the at least two antenna elements in a length direction, and direction of current flowing in each of the at least two antenna elements are set to be oriented outwardly from the center of the at least two antenna elements in the length direction or inwardly toward the center in the length direction.

An even number of antenna elements may be disposed in a portion of the substrate, and each pair of antenna elements among the even number of antenna elements may be spaced apart from each other in a facing manner.

According to another general aspect, an antenna apparatus includes: a feed point and at least a pair of opposing coil elements, the opposing coil elements being substantially equidistantly spaced from the feed point, wherein the coils are configured to have a complementary direction of current flow.

The current may flow outwardly through both coils or inwardly, through both coils towards the feed point.

The antenna apparatus may further include at least two pairs of opposing coil elements, each pair disposed transverse to the other pair.

The antenna apparatus may further include a processor to selectively change the direction of current flow by responsively actuating switches to reconfigure connections amongst the coils.

The antenna apparatus may further include a substrate.

The antenna apparatus may further include a magnetic shielding member disposed on an outward face of a coil member distal to the feed point.

A winding direction of each of the pair of coils may be the same.

Other features and aspects will be apparent from the following detailed description, the drawings, and the claims.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1A is a perspective view schematically illustrating an example of an antenna apparatus according to an embodiment;

FIG. 1B is a side view schematically illustrating an antenna apparatus according to an embodiment;

FIG. 1C is a view schematically illustrating a configuration in which a feeder is connected to an antenna apparatus;

FIGS. 2A and 2B are a perspective view and a side view schematically illustrating an antenna apparatus according to an embodiment in which current directions are set to be different from those of FIGS. 1A and 1B;

FIG. 3A is a diagram illustrating an H field distribution on an X axis of an antenna apparatus according to an embodiment;

FIG. 3B is a diagram illustrating an H field distribution on a Y axis of an antenna apparatus according to an embodiment;

FIG. 3C is a diagram illustrating an H field distribution of a Z axis of an antenna apparatus according to an embodiment;

FIGS. 4A, 4B, and 4C are diagrams illustrating a recognition region distribution according to distances between antenna elements of an antenna apparatus according to an embodiment;

FIGS. 5A and 5B are perspective views schematically illustrating an antenna apparatus;

FIG. 6A is a diagram illustrating an H field distribution on an X axis of an antenna apparatus;

FIG. 6B is a diagram illustrating an H field distribution on a Y axis of an antenna apparatus; and

FIGS. 7A, 7B, and 7C are perspective views schematically illustrating antenna apparatuses.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent to one of ordinary skill in the art. The sequences of operations described herein are merely examples, and are not limited to those set forth herein, but may be changed as will be apparent to one of ordinary skill in the art, with the exception of operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

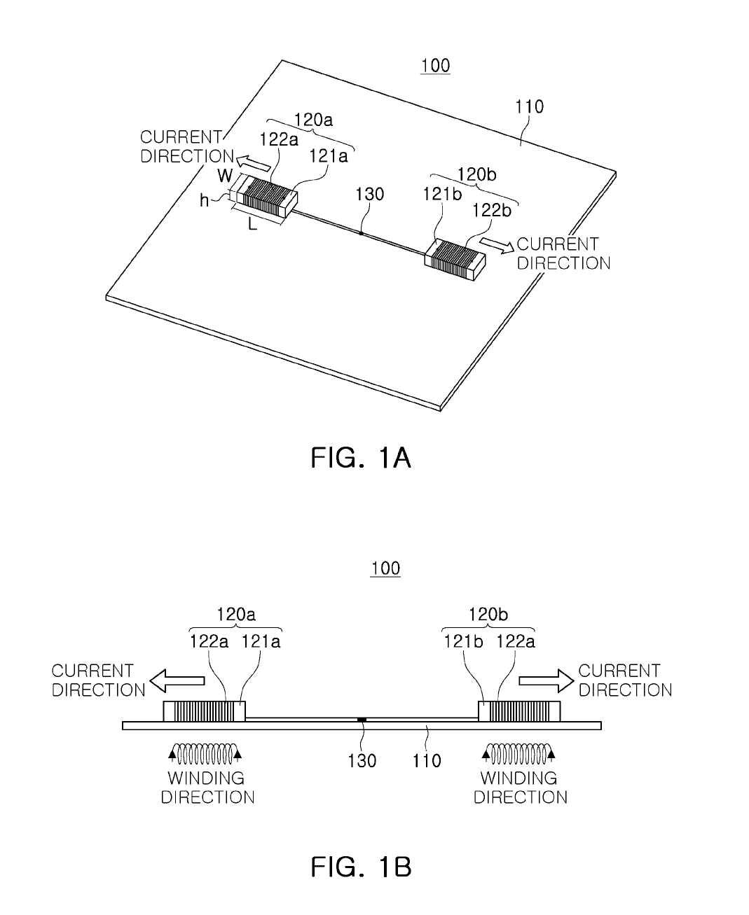

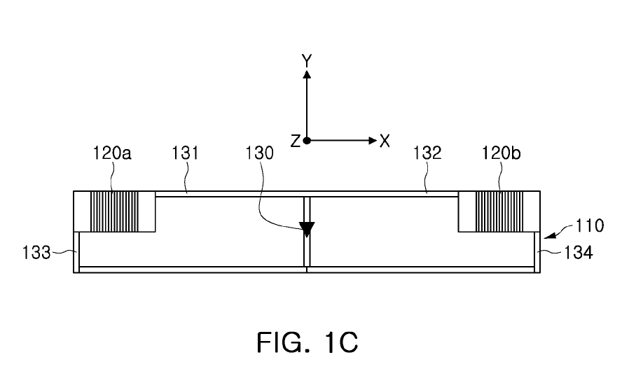

FIG. 1A is a perspective view schematically illustrating an antenna apparatus according to an embodiment, FIG. 1B is a side view schematically illustrating the antenna apparatus according to an embodiment, and FIG. 1C is a view schematically illustrating a configuration in which a feeder is connected to an antenna apparatus.

Referring to FIGS. 1A and 1B, an example antenna apparatus 100 includes a plurality of antenna elements 120a and 120b disposed on a substrate 110 having a predetermined area.

The plurality of antenna elements 120a and 120b may include, for example, a first antenna element 120a and a second antenna element 120b.

The first antenna element 120a and the second antenna element 120b may be spaced apart from each other at a predetermined distance in a facing manner. For example, the first antenna element 120a and the second antenna element 120b may each be a hexahedron having a predetermined length L, a predetermined width W, and a predetermined height H. The first antenna element 120a and the second antenna element 120b may be disposed such that one surface of the first antenna element 120a and the second antenna element 120b face each other.

In the first antenna element 120a and the second antenna element 120b, conductors 122a and 122b may be wound around magnetic bodies 121a and 121b, respectively. Insulators may be provided on outer surfaces of the first antenna element 120a and the second antenna element 120b in order not to expose the conductors 122a and 122b outwardly, but may be omitted in the drawings in order allow the winding of the conductors 122a and 122b to be more clearly illustrated.

As illustrated, power may be supplied to the first antenna element 120a and the second antenna element 120b, and a direction of a current may be set according to the feeding or winding direction.

For example, as illustrated, directions of current fed to flow in the first antenna element 120a and the second antenna element 120b may be set to be oriented outwardly from substantially the center of the distance between the first antenna element 120a and the second antenna element 120b, in a length direction of each of the antenna elements 120a and 120b.

Referring to FIG. 1C, when the antenna apparatus 100 according to an embodiment is viewed from above, a feed point 130 may be provided at the center of the distance between the first antenna element 120a and the second antenna element 120b, and power feed lines 131, 132, 133, and 134 may be electrically connected to both ends of the first antenna element 129a and the second antenna element 120b.

For example, in a case in which conductors are wound in the directions of the arrows in the first antenna element 120a and the second antenna element 120b, positive power feed lines 131 and 132 may be respectively connected to one end (a) of the first antenna element 120a and one end (b) of the second antenna element 120b and negative power feed lines 133 and 134 may be respectively connected to the other end (c) of the first antenna element 120a and the other end (d) of the second antenna element 120b, in order to set directions of currents flowing in the antenna elements to be oriented outwardly from the center of the distance between the first antenna element 120a and the second antenna element 120b, in the length direction as illustrated.

If winding directions of the conductors of the first antenna element 120a and the second antenna element 120b are the same, in order to set directions of currents flowing in the antenna elements as illustrated, the positive power feed line 132 may be connected to the other end (d) of the second antenna element 120b and the negative power feed line 134 may be connected to the one end (b) of the second antenna element 120b.

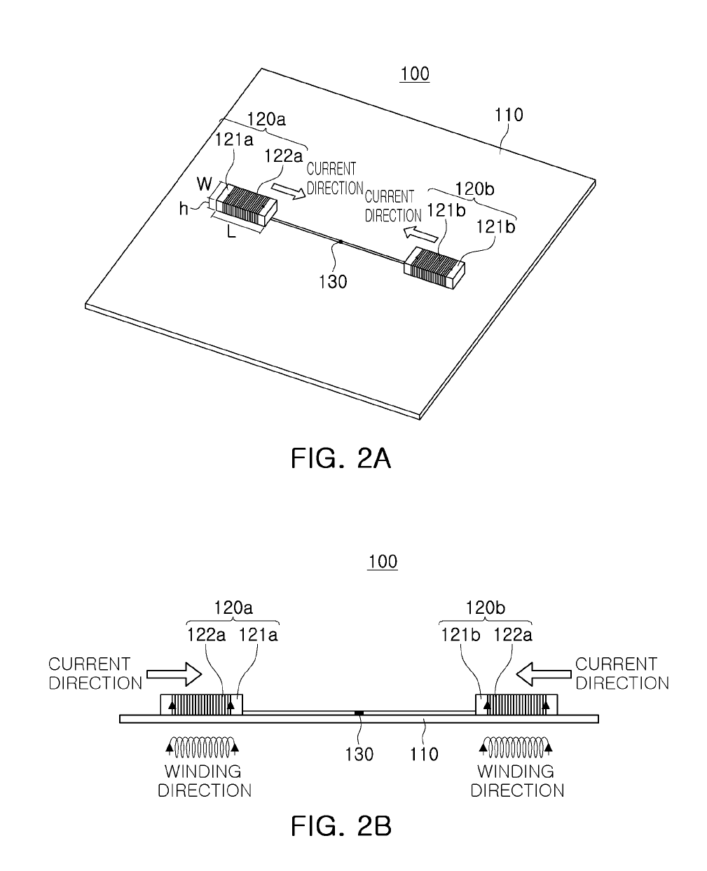

FIGS. 2A and 2B are a perspective view and a side view schematically illustrating an antenna apparatus according to a configuration in which current directions are set to be different from those of FIGS. 1A and 1B.

Referring to FIGS. 2A and 2B, in the antenna apparatus 100 according to another configuration, directions of currents flowing in the first and second antenna elements 120a and 120b may be set to be oriented inwardly toward the center of the distance between the first antenna element 120a and the second antenna element 120b, in a length direction of each of the antenna elements 120a and 120b, opposite to the directions of the currents illustrated in FIGS. 1A and 1B.

For example, referring to FIG. 1C, when the winding directions of the conductors of the first antenna element 120a and the second antenna element 120b oppose each other, the positive power feed lines 131 and 132 may respectively be connected to the other end (c) of the first antenna element 120a and the other end (d) of the second antenna element 120b and the negative power feed lines 133 and 134 may respectively be connected to one end (a) of the first antenna element 120a and one end (b) of the second antenna element 120b.

When the winding directions of the conductors of the first antenna element 120a and the second antenna element 120b are the same, the positive power feed line 132 may be connected to one end (b) of the second antenna element 120b and the negative power feed line 134 may be connected to the other end (d) of the second antenna element 120b, in order to set directions of currents flowing in the antenna elements to be oriented inwardly toward the center of the distance between the first antenna element 120a and the second antenna element 120b, in the length direction of the antenna elements.

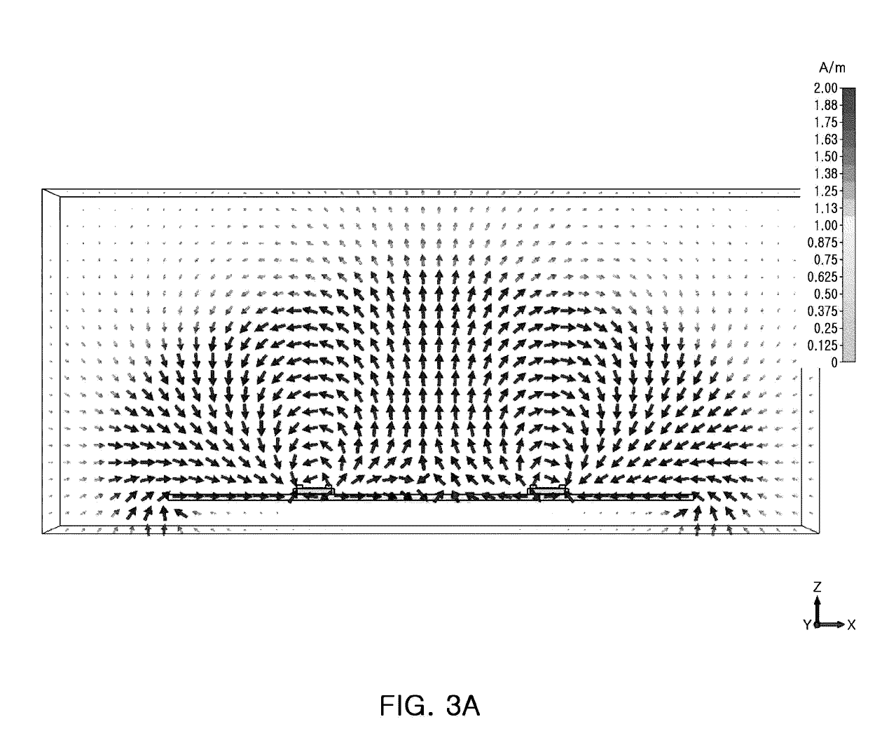

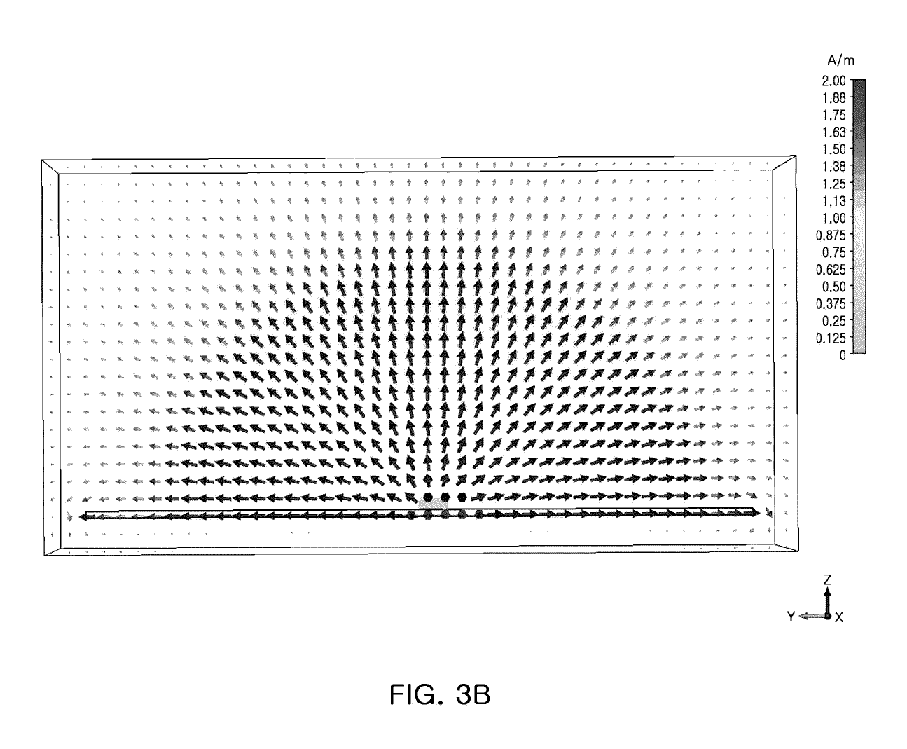

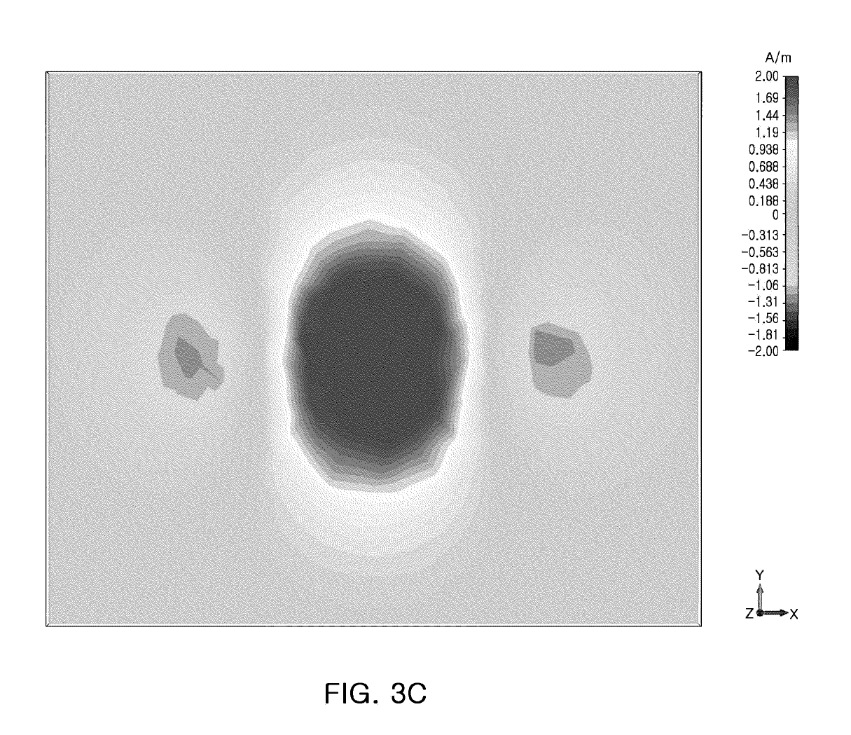

FIG. 3A is a diagram illustrating an exemplary H field distribution on an X axis of an antenna apparatus, FIG. 3B is a diagram illustrating an H field distribution on a Y axis of an antenna apparatus, and FIG. 3C is a diagram illustrating an H field distribution of a Z axis of an antenna apparatus.

FIG. 3A shows an exemplary H-Field (peak) with a monitor configured for the h-field with f=13.56[AC1], plane at y=0, with maximum-2D 1651.2 A/m at 40.7447/1.2224e-014/-0.367 at a frequency of 13.56 and phase of 202.5 degrees. FIG. 3B shows an exemplary H-Field (peak) with a monitor configured for the h-field with f=13.56[AC1], plane at x=20, with maximum-2D 263.556 A/m at 20/−1.83721/−0.890909 at a frequency of 13.56 and phase of 202.5 degrees. FIG. 3C shows an exemplary H-Field (peak) with a monitor configured for a z component of the h-field with plane at z=30, with maximum-2D 3.31252 A/m at 15.8321/−3.4541/30 at a frequency of 13.56 and phase of 202.5 degrees.

It can be seen that, due to the directions of the currents fed to the first and second antenna elements 120a and 120b of the antenna apparatus 100 according to an embodiment illustrated in FIGS. 1A through 1C or FIGS. 2A and 2B, magnetic flux (H field) concentrates within the distance between the first and second antenna elements 120a and 120b as illustrated in FIGS. 3A through 3C.

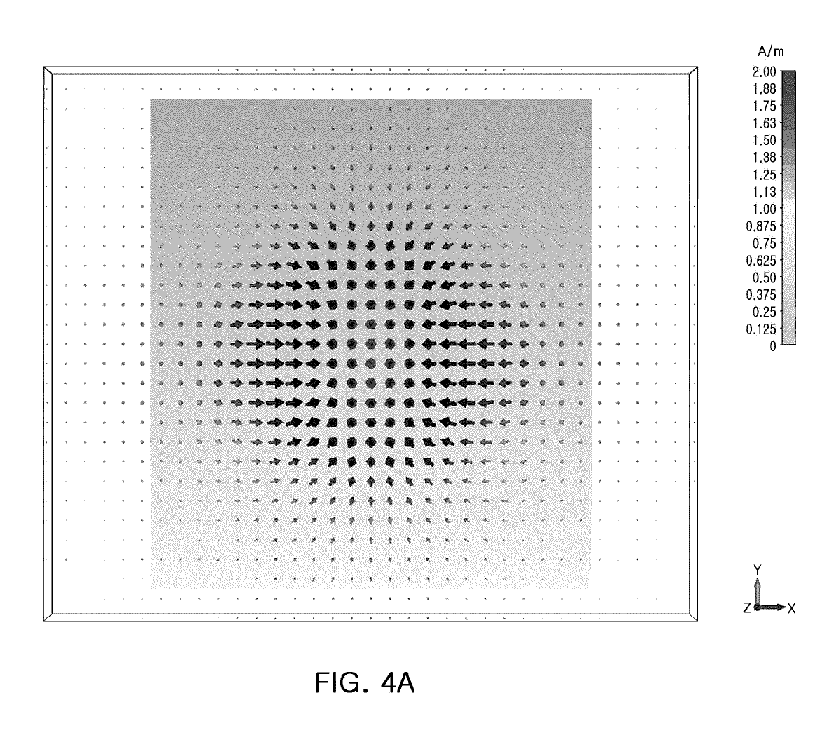

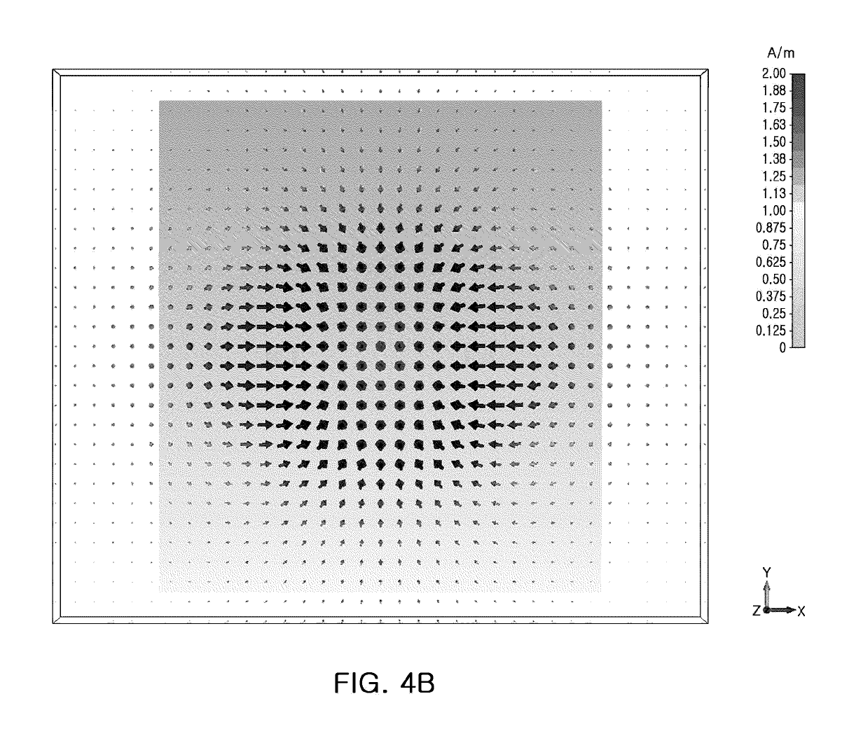

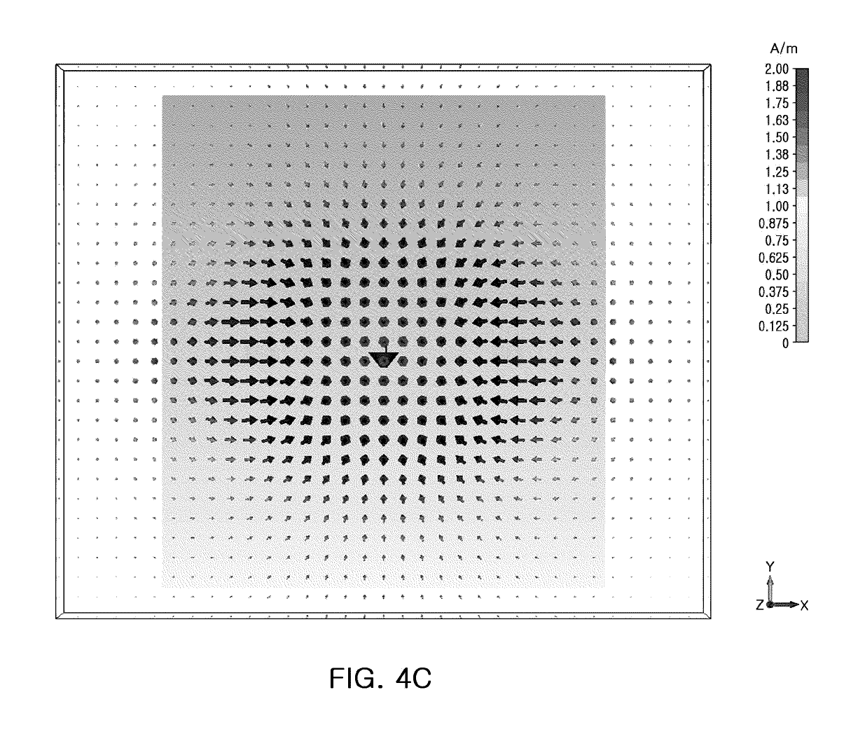

FIGS. 4A, 4B, and 4C are diagrams illustrating a recognition region distribution according to distances between antenna elements of an antenna apparatus.

Referring to FIGS. 4A, 4B, and 4C, recognition regions that may be recognized by a counterpart antenna able to transmit and receive a signal or power to and from the antenna apparatus when distances between the first and second antenna elements 120a and 120b are set to about 30 mm (FIG. 4A), about 40 mm (FIG. 4B), and about 50 mm (FIG. 4C), respectively, are illustrated.

The foregoing recognition regions may be related to signal transmission or power transmission efficiency with the counterpart antenna, and, for example, signal or power transmission/reception efficiency may be significantly increased when a distance from an end of the first antenna element 120a to the an end of the second antenna element 120b is substantially the same as a length of the antenna of the counterpart.

FIG. 4A shows an exemplary H-Field (peak) with a monitor configured for the h-field with f=13.56[AC1], plane at z=30, with maximum-2D 35.2931 A/m at 15/2/30 at a frequency of 13.56 and phase of 0 degrees. FIG. 4B shows an exemplary H-Field (peak) with a monitor configured for the h-field with f=13.56[AC1], plane at z=30, with maximum-2D 3.3215 A/m at 16.1765/−1.92857/30 at a frequency of 13.56 and phase of 0 degrees. FIG. 4C shows an exemplary H-Field (peak) with a monitor configured for the h-field with f=13.56[AC1], plane at z=30, with maximum-2D 2.93744 A/m at 40.2941/2/30 at a frequency of 13.56 and phase of 0 degrees.

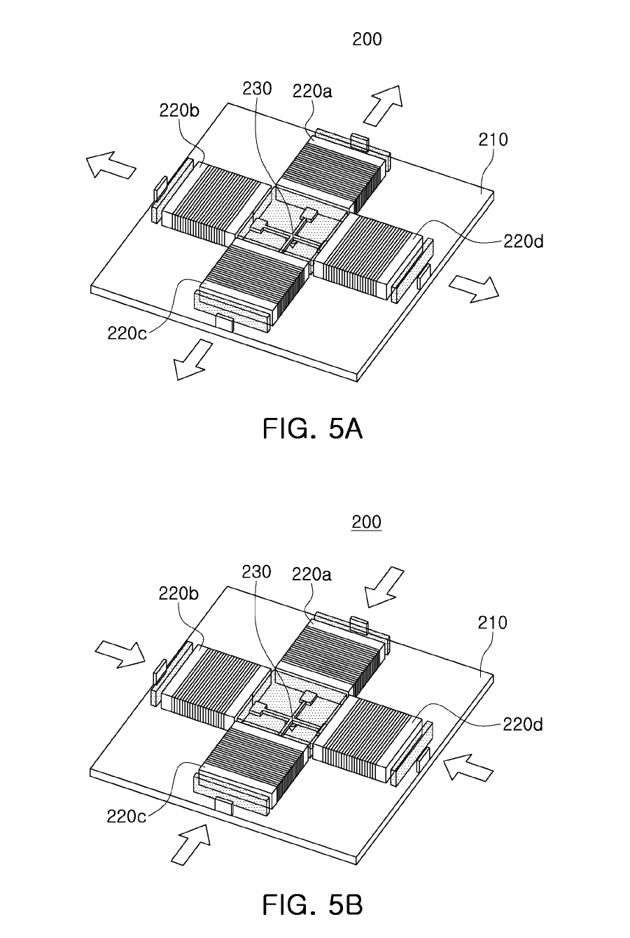

FIGS. 5A and 5B are perspective views schematically illustrating an antenna apparatus according to another configuration.

Referring to FIGS. 5A and 5B, in the antenna apparatus 200, first to fourth antenna elements 220a, 220b, 220c, and 220d may be disposed in predetermined regions of the substrate 210, and here, among the first to fourth antenna elements 220a, 220b, 220c, and 200d, the first antenna element and the third antenna element 220c form a pair and the second antenna element 220b and the fourth antenna element 220d form another pair. The antenna elements forming pairs may be disposed such that one surface thereof in a width direction face each other.

As illustrated in FIG. 5A, directions of currents flowing in the first to fourth antenna elements 220a, 220b, 220c, and 200d may be set to be oriented outwardly from the center of a distance between the first antenna element 220a and the third antenna element 220c or from the center of a distance between the second antenna element 220c and the fourth antenna element 220d outwardly in a length direction, or may be set to be oriented inwardly toward the center in the length direction as illustrated in FIG. 5B.

Connections of feeders of feed points and winding directions may refer to the descriptions of FIG. 1C and will be omitted here for conciseness and clarity of disclosure.

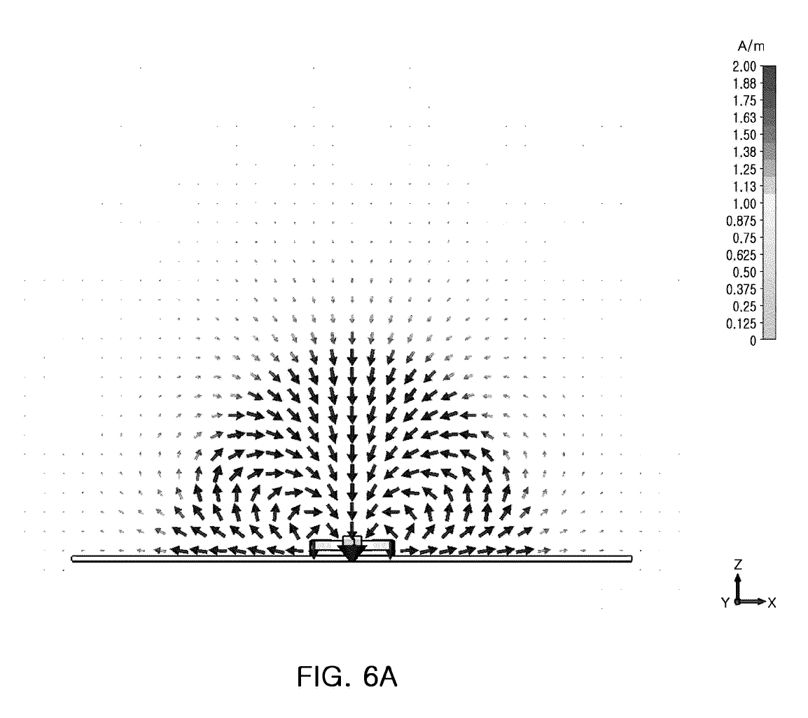

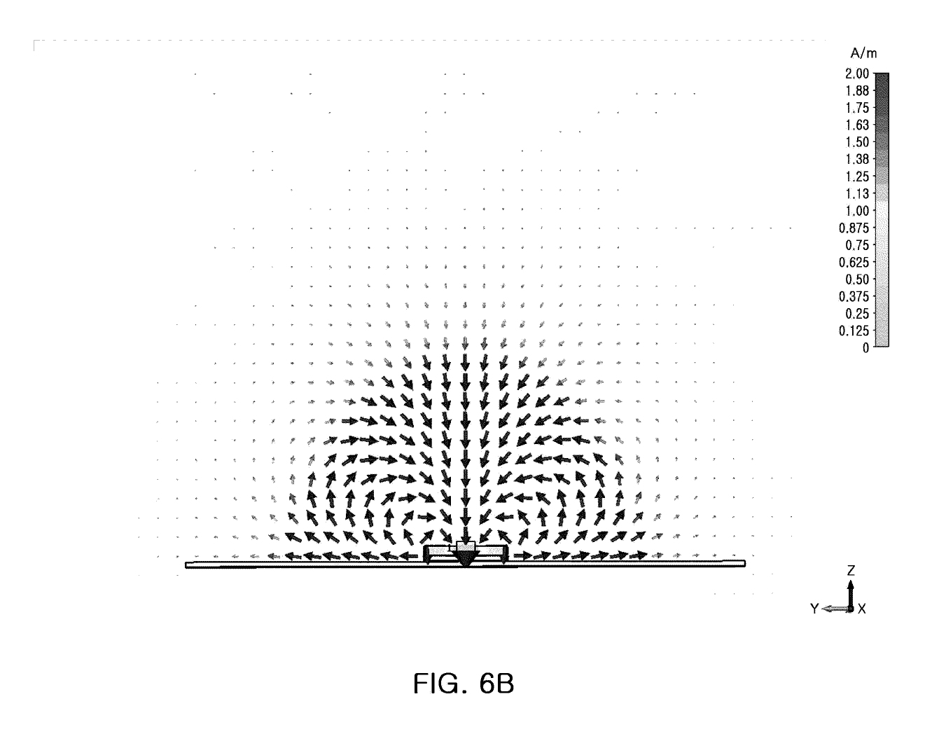

FIG. 6A is a diagram illustrating an H field distribution on an X axis, and FIG. 6B is a diagram illustrating an H field distribution on a Y axis of an antenna apparatus according to another configuration.

Referring to FIGS. 6A and 6B, it can be seen that, in the antenna apparatus according to the configuration illustrated in FIGS. 5A and 5B, magnetic flux (H field) concentrates on the center of the distance between the first antenna element 220a and the third antenna element 220c or on the center of the distance between the second antenna element 220b and the fourth antenna element 220d. FIG. 6A shows an exemplary H-Field (peak) with a monitor configured for the h-field with f=13.56[AC1], plane at y=0, with maximum-2D 2971.45 A/m at 4.11765/1.21422e-014/−0.0535714 at a frequency of 13.56 and phase of 0 degrees. FIG. 6B shows an exemplary H-Field (peak) with a monitor configured for the h-field with f=13.56[AC1], plane at x=0, with maximum-2D 3109.45 A/m at 1.21422e-014/−4.11765/0.053 at a frequency of 13.56 and phase of 0 degrees.

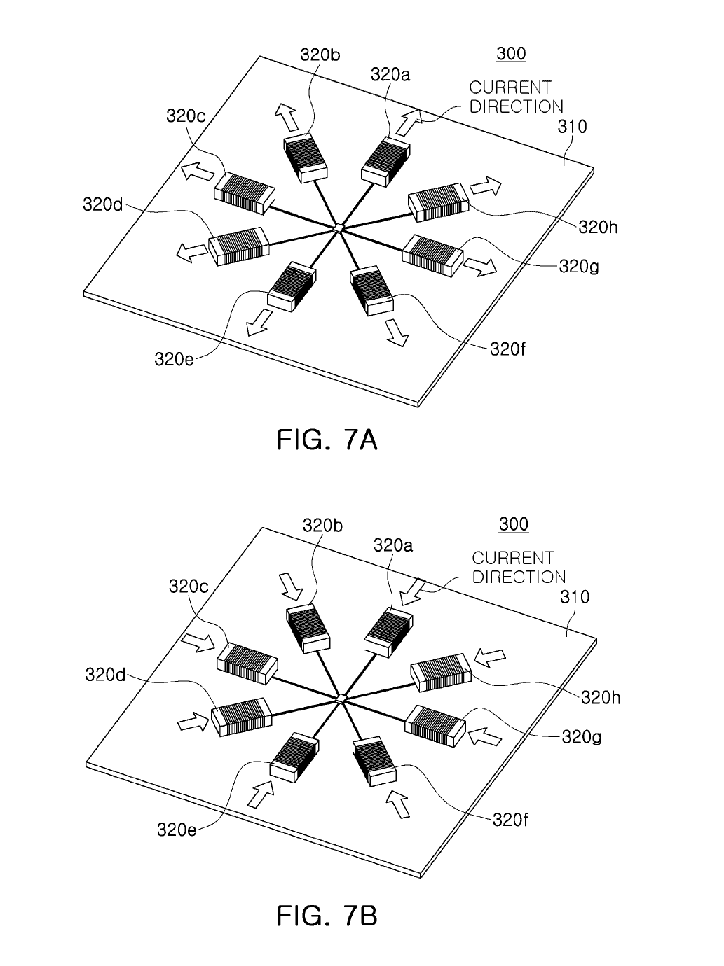

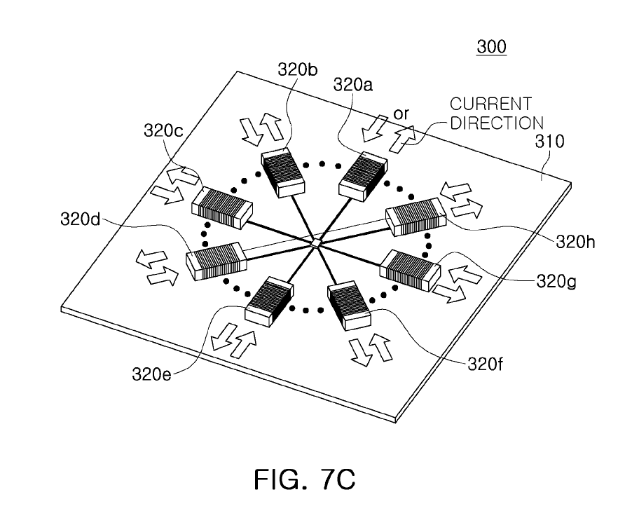

FIGS. 7A, 7B, and 7C are perspective views schematically illustrating antenna apparatuses according to other configurations.

Referring to FIGS. 7A and 7B, in an antenna apparatus 300 according to another exemplary configuration, first to eighth antenna elements 320a, 320b, 320c, 320d, 320e, 320f, 320g, and 320h are disposed on a substrate 310. The first antenna element 320a and the fifth antenna element 320e are paired and disposed such that one surface of each in a width direction face each other. The second antenna element 320b and the sixth antenna element 320f, the third antenna element 320c and the seventh antenna element 320g, and the fourth antenna element 320d and the eighth antenna element 320h are paired and disposed such that one surface of each antenna element in a pair in the width direction face each other.

Directions of currents flowing in the antenna elements may be set to be oriented inwardly toward the center in a length direction of each of the antenna elements, or conversely, may be oriented from the center outwardly in the length direction. Magnetic flux according to orientation may be similar to that illustrated in FIGS. 6A and 6B, and connections of feeders or winding directions of conductors may refer to the descriptions of FIG. 1C.

Referring to FIG. 7C, in an antenna apparatus 400 according to another exemplary configuration, eight or more antenna elements 420a, 420b, 420c, 420d, 420e, 420f, 420g, and 420h are disposed on a substrate 410 and paired to each other. The paired antenna elements may be respectively disposed such that one surface of each paired antenna element in a width direction face each other.

Directions of currents flowing in the antenna elements may be set to be oriented inwardly toward the center in a length direction of each of the antenna elements, or conversely, may be oriented from the center outwardly in the length direction. Magnetic flux according to orientation may be similar that illustrated in FIGS. 6A and 6B, and connections of feeders or winding directions of conductors may refer to the descriptions of FIG. 1C.

As described above, in some configurations, loss of current induced to a counterpart antenna exchanging a signal or power is reduced and a region or a communications distance in which a current equal to or greater than a predetermined amount is induced may be extended.

As set forth above, in some configurations, loss of current induced in a counterpart antenna exchanging a signal or power is reduced and a region or a communications distance in which a current equal to or greater than a predetermined amount is induced may be extended.

One or more processors may be employed to selectively actuate a plurality of switches coupled to the feed point and ends of the coils to dynamically change direction of current flow therethrough. The processor may comprise one or more controllers, sensors, generators, drivers, and any other electronic components known to one of ordinary skill in the art. In one example, the hardware components are implemented by one or more processors or computers. A processor or computer is implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices known to one of ordinary skill in the art that is capable of responding to and executing instructions in a defined manner to achieve a desired result. In one example, a processor or computer includes, or is connected to, one or more memories storing instructions or software that are executed by the processor or computer. Hardware components implemented by a processor or computer execute instructions or software, such as an operating system (OS) and one or more software applications that run on the OS, to perform the operations described herein. The hardware components also access, manipulate, process, create, and store data in response to execution of the instructions or software. For simplicity, the singular term “processor” or “computer” may be used in the description of the examples described herein, but in other examples multiple processors or computers are used, or a processor or computer includes multiple processing elements, or multiple types of processing elements, or both. In one example, a hardware component includes multiple processors, and in another example, a hardware component includes a processor and a controller. A hardware component has any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An antenna apparatus comprising:
a plurality of antenna elements,
wherein the plurality of antenna elements are spaced apart from one another, and a direction of current flowing in each of the plurality of antenna elements is set to be oriented outwardly from substantially the center of the plurality of antenna elements in a length direction of each of the plurality of antenna elements or inwardly toward the center in the length direction of each of the plurality of antenna elements.

2. The antenna apparatus of claim 1, wherein the number of the plurality of antenna elements is two n-squared, n being a natural number greater than 0.

3. The antenna apparatus of claim 1, wherein the center is provided as a feed point.

4. The antenna apparatus of claim 1, wherein winding direction of conductors of each of the plurality of antenna elements are the same as or opposite to each other, according to the directions of current.

5. An antenna apparatus comprising:
at least two antenna elements spaced apart from each other in a facing manner in a portion of a substrate,
wherein conductors are wound around the at least two antenna elements in a length direction, and direction of current flowing in each of the at least two antenna elements are set to be oriented outwardly from the center of the at least two antenna elements in the length direction or inwardly toward the center in the length direction.

6. The antenna apparatus of claim 5, wherein the number of the at least two antenna elements is two n-squared, n being a natural number greater than 0.

7. The antenna apparatus of claim 5, wherein a feed point is formed substantially at the center.

8. The antenna apparatus of claim 5, wherein winding direction of conductors of each of the at least two antenna elements is the same as or opposite to each other, according to the directions of current.

9. The antenna apparatus of claim 5, wherein an even number of antenna elements disposed in a portion of the substrate are provided, and
each pair of antenna elements among the even number of antenna elements are spaced apart from each other in a facing manner.

10. An antenna apparatus comprising:
a feed point;
at least a pair of opposing coil elements, the opposing coil elements being substantially equidistantly spaced from the feed point, wherein the coils are configured to have a complementary direction of current flow.

11. The antenna apparatus of claim 10, wherein the current flows outward through both coils or inward, through both coils towards the feed point.

12. The antenna apparatus of claim 10, further comprising at least two pairs of opposing coil elements, each pair disposed transverse to the other pair.

13. The antenna apparatus of claim 10, further comprising a processor to selectively change the direction of current flow by responsively actuating switches to reconfigure connections amongst the coils.

14. The antenna apparatus of claim 10, further comprising a substrate.

15. The antenna apparatus of claim 10, further comprising a magnetic shielding member disposed on an outward face of a coil member distal to the feed point.

16. The antenna apparatus of claim 10, wherein a winding direction of each of the pair of coils is the same.
